(19) United States
(12) Patent Application Publication
(10) Pub. No.: US 2012/0321297 A1
(43) Pub. Date: Dec. 20, 2012

(54) ROUTING AND VALIDATION OF PATHS IN A WAVELENGTH SWITCHED OPTICAL NETWORK

(76) Inventors: Giulio Bottari, Livorno (IT); Diego Caviglia, Savona (IT)

(21) Appl. No.: 13/516,224

(22) PCT Filed: Dec. 14, 2009
(86) PCT No.: PCT/EP2009/067044

§ 371 Date: Aug. 24, 2012

(51) Int. Cl. H04B 10/08

(52) U.S. Cl. 398/26; 398/28

(57) ABSTRACT

A network comprises nodes connected by optical sections. The nodes support a plurality of traffic types. A candidate optical path having a first traffic type is selected as a routing for at least part of the connection on the basis of at least one routing metric. Pre-computed parameters are retrieved for the optical sections of the candidate optical path. The pre-computed parameters are indicative of quality of transmission along the optical section for the first traffic type. A quality of transmission is determined along the candidate optical path using the retrieved parameters. The pre-computed parameters for each of the optical sections can be used at a network planning tool and then exported to a network management system or a path computation entity at a node for creating a validation module for use in validating connections across the optical transmission network.

### TECHNICAL FIELD

This invention relates to a method of routing and validation of optical paths in an optical transmission network, such as a Wavelength Switched Optical Network (WSON), and to apparatus for performing the method.

### BACKGROUND

A Wavelength Switched Optical Network (WSON) supports end-to-end optical paths, called lightpaths, between nodes requiring connection in the network. Intermediate nodes in this type of network support wavelength switching and may also support wavelength conversion. In contrast with point-to-point optical communication links which provide high-capacity transport, always between the same pair of nodes, a WSON supports the setting up and tearing down of lightpaths between pairs of nodes of a network having a more complex topology, such as a ring, interconnected rings or mesh topology. A Routing and Wavelength Assignment (RWA) function of the WSON performs the tasks of routing a lightpath across the WSON and assigning a wavelength to the lightpath.

Transmission at optical wavelengths suffers from a range of impairments and it is advantageous to verify the feasibility of an end-to-end lightpath across a WSON before the lightpath is used to carry traffic. The process of checking the feasibility of an optical path is called impairment validation (IV) and can be performed by a software tool which analyses impairments (linear and non-linear) accumulated during optical signal propagation and the characteristics of the hardware crossed by the optical signal (e.g. amplifier types, fibre types). A Quality of Transmission (QoT) parameter is evaluated and compared with a threshold which represents a desired maximum Bit Error Rate at the receiver, e.g. 10E-15. Conventionally, a network calculation entity evaluates the QoT of the optical path, and operates off-line. The Ericsson term for this entity is a Photonic Link Design Engine (PLDE).

A review of Impairment Aware Routing and Wavelength Assignment (IA-RWA) in optical networks is given in an Internet Engineering Task Force (IETF) document “A Framework for the Control of Wavelength Switched Optical Networks (WSON) with Impairments”, draft-bernstein-ccamp-wson-impairments-05.txt. One possible approach to performing Impairment Aware Routing and Wavelength Assignment (IA-RWA) is for a Routing and Wavelength Assignment (RWA) function to select a routing of a lightpath and then make a call to an Impairment Validation (IV) function to validate the lightpath. However, the complex computations required to validate the lightpath can make it difficult to perform IA-RWA in real time. Also, if a lightpath selected by the RWA function is deemed unacceptable by the IV function, an alternative lightpath must be routed and validated, causing a further delay to setting up the lightpath.

### SUMMARY

In a first aspect, the present invention provides a method of performing routing and validation of a connection across an optical transmission network. The network comprises nodes connected by optical sections, the nodes supporting a plurality of traffic types. The method comprises selecting a candidate optical path as a routing for at least part of the connection on the basis of at least one routing metric. The candidate optical path has a first traffic type. The method further comprises retrieving pre-computed parameters for the optical sections of the candidate optical path. The pre-computed parameters are indicative of quality of transmission along the optical section for the first traffic type. The method further comprises determining a quality of transmission along the candidate optical path using the retrieved parameters.

The method uses per-optical section, and per-traffic type (interface) parameters, which have been pre-calculated for the optical sections of the network. At the time of routing, the previously calculated parameters for the optical sections of a possible path are analytically combined to obtain a good approximation of the overall path QoT. The method can significantly reduce the computation time and the amount of resources (CPU, memory, etc.) needed to assess the feasibility of a lightpath at the time of routing. An advantage of the method is that resources are efficiently used to validate optical paths that meet the routing requirements for the connection, such as cost or delay.

The term “traffic type” refers to a type of traffic supported by an interface of the optical section. A traffic type can comprise at least one of: a bit rate (e.g. 2.5 G, 10 G, 40 G), a line coding type (e.g. Return-to-Zero (RZ), Non-Return-to-Zero (NRZ), ODB) and a modulation type (e.g. Differential Phase Shift Keying (DPSK), Differential Quadrature Phase Shift Keying (DQPSK)). The traffic type can be defined in other ways, in addition to, or instead of, those listed.

Advantageously, the method is performed iteratively, with each iteration of the method comprising: selecting a candidate optical path as a routing for at least the first part of the connection; determining if the quality of transmission along the candidate optical path is acceptable; and modifying the candidate optical path if the quality of transmission is not acceptable. This method can be performed on an optical section-by-optical section basis.

Advantageously, the method is performed in response to a dynamic request for an optical connection across the optical transmission network.

Advantageously, the at least one routing metric is selected from the group comprising: administrative cost, delay.

Advantageously, the step of determining a quality of transmission along the candidate optical path determines at least one parameter indicative of quality of transmission for a composite path comprising multiple optical sections by operating on the retrieved parameters for optical sections in the composite path.

The method is particularly useful in networks having a complex topology, such as mesh, ring or interconnected rings.

Another aspect of the invention provides a method for use in an optical transmission network comprising nodes connected by optical sections comprising determining, for each of the optical sections, parameters indicative of transmission quality along the optical section for a plurality of different traffic types. The method further comprises storing the determined parameters for each of the optical sections at a network planning tool and exporting the parameters to at least one of: a network management system and a path computation entity at a node for creating a validation module for use in validating connections across the optical transmission network.

Further aspects of the invention provide apparatus for performing the methods. In particular, an aspect of the invention provides apparatus for performing routing and validation of a connection across an optical transmission network, the network comprising nodes connected by optical sections, the nodes supporting a plurality of traffic types. The apparatus comprises a routing module which is arranged to select a candidate optical path as a routing for at least part of the connection on the basis of at least one routing metric, the candidate optical path having a first traffic type. The apparatus further comprises a validation module which is arranged to retrieve pre-computed parameters for the optical sections of the candidate optical path, the pre-computed parameters being indicative of quality of transmission along the optical section for the first traffic type and to determine a quality of transmission along the candidate optical path using the retrieved parameters.

The apparatus is further arranged to perform any of the described or claimed method steps.

The functionality described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to the perform the required functions. Another aspect of the invention provides machine-readable instructions (software) which, when executed by a processor, perform any of the described or claimed methods. The machine-readable instructions may be stored on an electronic memory device, hard disk, optical disk or other machine-readable storage medium. The machine-readable instructions can be downloaded to the storage medium via a network connection.

### BRIEF DESCRIPTION OF THE DRAWINGS

Embodiments of the invention will be described, by way of example only, with reference to the accompanying drawings in which:

FIG. 1 shows an optical communication network with a mesh topology of links between nodes according to an embodiment of the invention;

FIG. 2 shows a method of prevalidating an optical network according to an embodiment of the invention;

FIG. 3 shows an example of prevalidation calculations according to an embodiment of the invention;

FIG. 4 shows a method of routing and validating a path in an optical network according to an embodiment of the invention;

FIG. 5 shows iterations of a routing method applied to the network of FIG. 1;

FIGS. 6A-6C show alternative configurations of apparatus in a network according to embodiments of the invention;

FIG. 7 shows a planning tool according to an embodiment of the invention in more detail;

FIG. 8 shows a Network Management System (NMS) according to an embodiment of the invention in more detail;

FIG. 9 shows a method of using the prevalidated data in other nodes of the network according to an embodiment of the invention.

### DETAILED DESCRIPTION

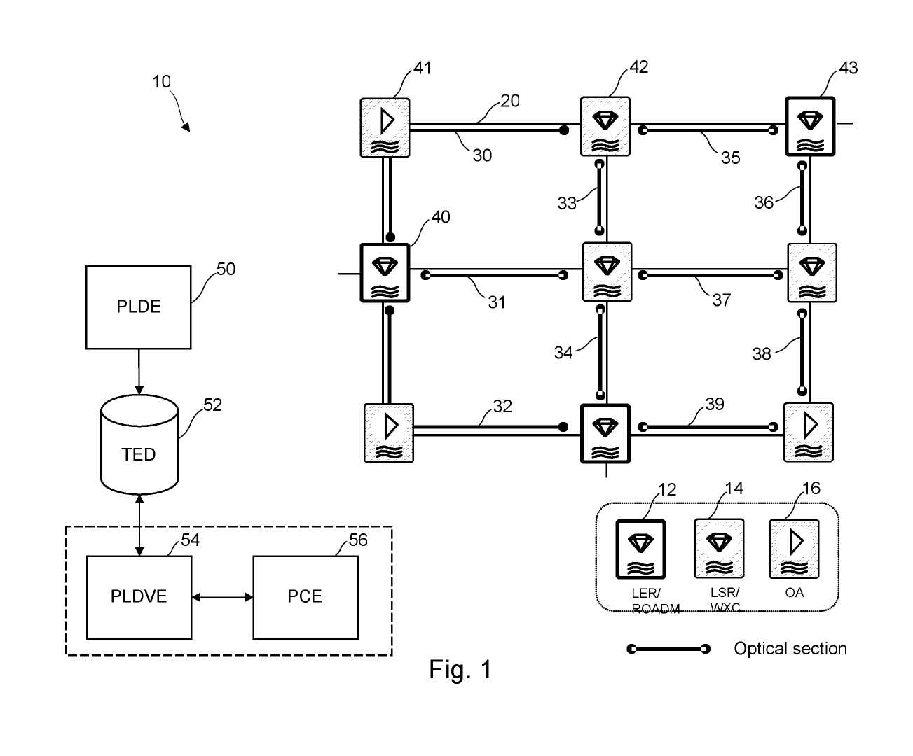

FIG. 1 shows an optical communication network 10 with a mesh topology of links 20 between nodes. Nodes of the network 10 comprise routers 12, 14 which are capable of switching traffic at particular wavelengths, and may also switch traffic between different wavelengths. Two types of router are shown in FIG. 1: Label Edge Routers (LER) 12 and Label Switching Routers (LSR) 14. Label Edge Routers (LER)/Reconfigurable Optical Add-Drop Multiplexers (ROADM) 12 are positioned at the edge of the network 10 and interface with other networks. LERs form endpoints of a lightpath. Label Switching Routers (LSR)/Wavelength Cross Connects (WXC) 14 with Wavelength Selective Switching (WSS) are positioned at intermediate nodes of the network 10 and are capable of switching traffic between different wavelengths, if required. The network can also include Optical Amplifiers (OA) 16 to amplify optical signals.

A lightpath for carrying traffic is established between a pair of LERs/ROADMs 12. As an example, a lightpath can be set up between node 40 and node 43 via node 42. The lightpath comprises an optical section 30 between nodes 40 and 42 and an optical section 35 between nodes 42 and 43. Optical section 31 includes an optical amplifier 41. At node 42 traffic may remain on the same wavelength, or it may be switched between wavelengths, so that the lightpath uses a first wavelength on optical section 30 and a second wavelength on optical section 35.

FIG. 1 also shows entities used in the planning and routing of lightpaths. A Photonic Link Design Engine (PLDE) 50 calculates parameters for interfaces of each optical section 30-39 of the network 10. The interface can be defined in terms of one or more of a bit rate, line coding type and modulation type. A set of parameters is calculated for interfaces supported by an optical section 30-39. The set of parameters for an interface of an optical section are indicative of transmission quality along the optical section, taking into account the traffic type (bit rate, modulation, line coding) and the impairments of the optical section. The PLDE 50 stores the calculated parameters for each interface and each optical section in a Traffic Engineering Database (TED) 52. A Path Computation Entity (PCE) 56 responds to requests for the routing of lightpaths in the network 10. The Path Computation Entity (PCE) 56 uses a Photonic Link Design Virtual Engine (PLDVE) 54 to determine the feasibility of possible routings of a requested lightpath across network 10. PLDVE 54 uses the pre-computed parameters, stored in TED 52, for each optical section 30-39 of the network 10 to determine whether a routing of the requested lightpath is feasible. Parameters for the optical sections in a candidate lightpath are analytically combined to determine if the path is feasible.

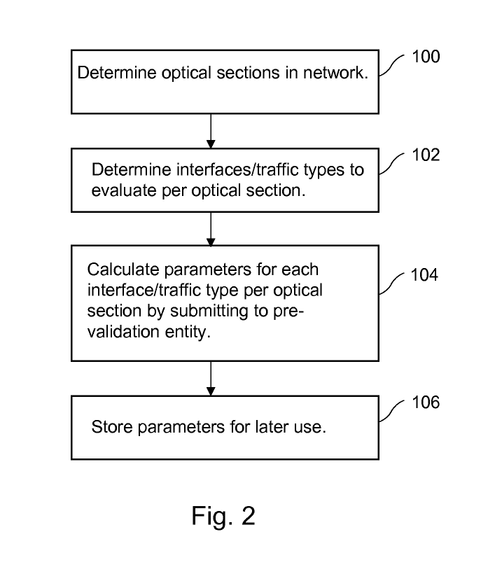

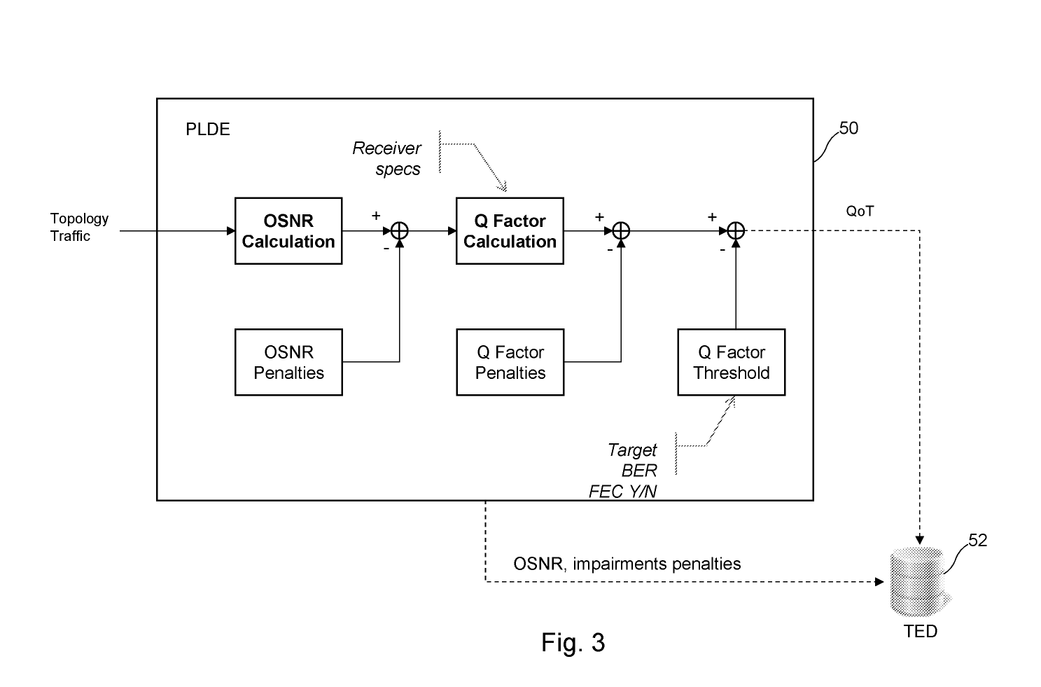

FIGS. 2 and 3 show an embodiment of an overall method of operating the network of FIG. 1. FIG. 2 shows preliminary steps to calculate parameters stored in the TED 52. This stage of the process will be called “prevalidation”. Firstly, at step 100, the method determines optical sections of the network, if the network has not already been partitioned into sections. The method can use a rule, or rule set, to determine optical sections. Typically, an optical section will comprise a link between two adjacent nodes of the network at which some wavelength switching or traffic add/drop function is performed, such as reconfigurable optical add-drop multiplexers (ROADM) or wavelength cross-connects (WXC) with wavelength selective switch (WSS) capabilities. Advantageously, the optical section does not include any intermediate node which is a ROADM or WXC. As an example, an optical section can comprise: [ROADM-link-OA-link-OA-link-WXC], because no wavelength switching occurs at the Optical Amplifiers (OA). One way of performing this rule is: scan each ROADM and each WXC and look at its adjacent links; move on link-by-link until another ROADM or WXC is reached, then “close” the optical section and mark the involved links as used (that is, already associated to a optical section). The process is repeated until all the links of the network are associated with an optical section. The end points of an optical section are not necessarily nodes where the wavelengths are originated/terminated. For example, in a WXC there is no termination because a WXC is an all optical device where the wavelength is switched optically. The result of step 100 is that the network is partitioned into N_{L} optical sections.

At step 102 the method determines which interfaces to evaluate for each optical section resulting from step 100. For example, an optical section may support 2.5 G, 10 G and 40 G interfaces, and there can be multiple interfaces at a particular bit rate which are each defined in terms of a line coding type and a modulation type. An example list of interfaces/traffic types supported by a node is given in Table 1. A particular node in the network may support a longer, or shorter, list of interfaces compared to other nodes in the network.

TABLE 1
list of interfaces/traffic types supported by a node
Interfaces

2.5G Type 1
2.5G Type 2
. . .
10G Type 1
10G Type 2
. . .
40G Type 1
40G Type 2
. . .

Step 102 can consider the full set of interfaces supported by a node. This will be described as complete prevalidation, and has an advantage that every interface at a node can be used by the RWA function. As an alternative to determining each interface supported by a node, step 102 can begin with a list of traffic types/interfaces that it is desired to support across a network and scan the interface list of each node to determine which of these are supported by the nodes. This will be described as partial prevalidation. In case of partial prevalidation, if the RWA function wants to use an interface which was not considered in the prevalidation phase it is necessary to return to calculate parameters for that interface before it can be used by the RWA function.

The N_{T} different traffic types/interfaces are stored in a traffic matrix T_{R}. At step 104 the method determines parameters for each interface/traffic type, in each of the N_{L} optical sections of the network. The N_{L} optical sections are submitted to the PLDE 50 and physically evaluated for each traffic type contained in the T_{R} array. An example list of parameters returned by the PLDE 50 is given below. The total number of PLDE invocations is N_{L}×N_{T}.

FIG. 3 schematically shows operation of the PLDE 50. The PLDE stores detailed data about optical sections, including the types of fibres, transponder/muxponder parameters, amplifier parameters. When the PLDE s invoked, it emulates the behaviour of light across the fibre and across the amplifiers/nodes of an optical section. Each optical impairment is considered and evaluated as a penalty to be addressed to the OSNR, or on Q factor. The evaluation of an optical section includes the transmitter (i.e. transmitting transponder/muxponder), receiver (i.e. receiving transponder/muxponder), and all fibre spans between the transmitter and receiver.

At step 106 values of the parameters determined at step 104 by the PLDE 50 are stored for later use. The parameters are stored in a TED 52. TED 52 now stores parameters which indicate the performance of each interface on each optical section of the network 10. The following table shows parameters resulting from the prevalidation of a network interface and optical section at a 2.5 G rate or 10 G rate.

TABLE 2
list of prevalidated parameters for an interface of an optical section

| Parameter | Description |
|---|---|
| OSNR_i,k | minimum received OSNR for the interface i over |
| | the path k under worst case conditions |
| Q_PMD_i,k | Polarisation Mode Dispersion (PMD) penalty on |
| | the Q factor |
| Q_CD_i,k | Chromatic Dispersion (CD) penalty on the Q |
| | factor |
| Q_NL_i,k | Nonlinear (NL) penalty on the Q factor |
| Q_L_i,k | Linear penalty on the Q factor (i.e. from filtering) |
| Q_sys_i,k | system penalty (i.e. uncertainties) |
| Q_bare_i,k | known threshold, after FEC. This is the lowest |
| | value that can be taken by Q_i (i.e. the most |
| | degraded signal that can be received) for the |
| | required signal quality after FEC |

The following table shows parameters resulting from the prevalidation of a network interface and optical section at a 40 G rate:

TABLE 3
list of prevalidated parameters for an interface of an optical section

| Parameter | Description |
|---|---|
| OSNR_i,k | minimum received OSNR for the interface i over |
| | the path k under worst case conditions (linear |
| | penalties included) |
| Q_NL_i,k | nonlinear (NL) penalty on the Q factor |
| Q_bare_i,k | known threshold, after FEC. This is the lowest |
| | value that can be taken by Q_i (i.e. the most |
| | degraded signal that can be received) for the |
| | required signal quality after FEC |

The sets of parameters listed above are examples, and it will be understood that the set of parameters can be longer, or shorter, than shown here. The set of parameters is calculated by an impairment calculation entity, such as an Ericsson PLDE.

The following table shows the resulting set of parameters for an interface of the type “2.5 G transponder” across a network comprising five optical sections. Numerical values in the table cells are the output of the prevalidation and are provided by the separate submitting of the optical sections to the PLDE. In this example there are five calls to the PLDE, one call per section. The input to the PLDE is the “topology” of the section, expressed in terms of: number of nodes and positioning, fiber types and length.

TABLE 4
parameter sets for an interface across a network
2.5G TRANSPONDER (traffic type i = 1)

| | Opt. Sec. 1 | Opt. Sec. 2 | Opt. Sec. 3 | Opt. Sec. 4 | Opt. Sec. 5 |
|---|---|---|---|---|---|
| Parameter | (k = 1) | (k = 2) | (k = 3) | (k = 4) | (k = 5) |
| OSNR_1,k | OSNR_1,1 | OSNR_1,2 | . . . | . . . | . . . |
| Q_PMD_1,k | Q_PMD_1,1 | Q_PMD_1,2 | . . . | . . . | . . . |
| Q_CD_1,k | Q_CD_1,1 | Q_CD_1,2 | . . . | . . . | . . . |
| Q_NL_1,k | Q_NL_1,1 | Q_NL_1,2 | . . . | . . . | . . . |
| Q_L_1,k | Q_L_1,1 | Q_L_1,2 | . . . | . . . | . . . |
| Q_sys_1,k | Q_sys_1,1 | Q_sys_1,2 | . . . | . . . | . . . |
| Q_bare_1,k | Q_bare_1,1 | Q_bare_1,2 | . . . | . . . | . . . |

When this table is complete, we can say that the traffic type “2.5 G TRANSPONDER” is prevalidated. As a consequence, the PLDVE can operate with such traffic type during the RWA.

In an embodiment of the invention, the prevalidation is not performed on a per wavelength channel basis but it is assumed that each link/span is crossed by the maximum number of channels (typically 40 or 80 channels, 160 in future systems). So, each optical section is processed by the PLDE assuming that the section is carrying the full load of channels. The real number of channels that will use this optical section in the real network is not known at this stage because this number is the output of the RWA. Only when all the traffic demands have been provisioned, is it possible to say how many channels are used in each link/span. So, in the prevalidation phase, which runs before the RWA, a worst case approach (validation for the maximum load) is used.

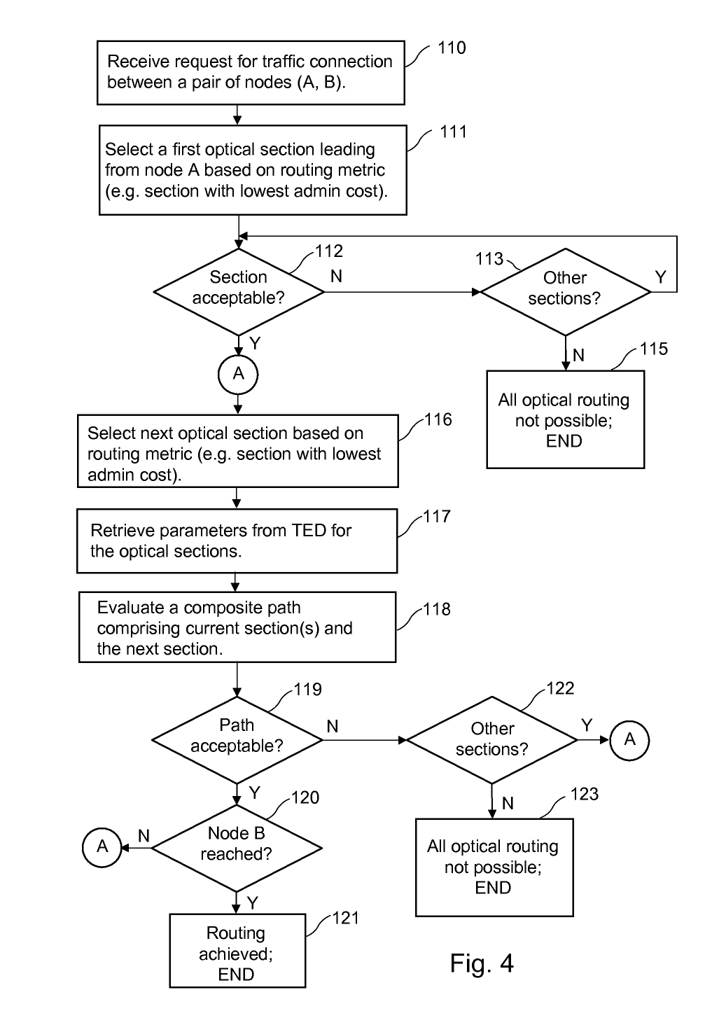

FIG. 4 shows a method of routing a connection across a network 10. The method begins at step 110 by receiving a request for a traffic connection between a pair of nodes A, B. The request for a connection will include parameters for the connection. The parameters can include: (i) the bit rate of the wavelength (2.5 G, 10 G, 40 G), (ii) the type of interface (the modulation type and line coding are implicit in this parameter); (iii) the type of recovery required; (iv) Source Node; (v) Destination Node. Other optional parameters which can be specified include: desired wavelength; administrative colour(s); disjointness between/among primary path and backup path(s); disjointness with already routed lightpath(s); setup-time/tear-down time; upgradability (that is, the lightpath is validated for interface 10_TypeX but is also validated for interface 40_TypeY so that, in the future, it's possible to upgrade the lightpath to higher bit rate).

At step 111 the method selects the first optical section leading from node A. Step 111 selects a first optical section which meets the parameters of the required connection. For example, if the connection requires a bit rate of 10 G, step 111 only considers interfaces which can support this bit rate. Additionally, step 111 selects an interface/optical section based on a routing metric such as administrative cost. Typically, a routing algorithm will attempt to find a route of lowest total cost. At step 112 the method determines if the quality of transmission (QoT) of the selected interface of the first optical section is acceptable. Step 112 can compare the stored parameters for the first optical section, retrieved from the TED, against values which are required for the requested connection. If the selected interface for the optical section is not acceptable, then step 113 checks if there are other possible optical sections leading from node A with an acceptable administrative cost. If there are no other possible optical sections of acceptable administrative cost the method ends at step 115. If there are other possible interfaces/optical sections, the method returns to step 112 and determines if the quality of transmission of the alternative interface/optical section is acceptable.

Once step 112 has found an acceptable interface on a first optical section, the method proceeds to step 116 and selects an interface on the next optical section, continuing from the node at the end of the first optical section. Step 116 selects an interface which meets the parameters in the request (received at step 110) and also makes the selection based on the routing metric of the sections (e.g. lowest administrative cost.) The method calculates values of parameters for the composite path comprising the interface on first optical section and the interface on the next optical section. Parameters for the interface on the next optical section are retrieved from the TED 52 at step 117. Step 118 evaluates the composite path, such as by using formulae described below. Step 119 compares the calculated parameters of the composite path against threshold values required for the requested connection. If the composite path is not acceptable, then step 122 retraces the last section and determines if there are other possible interfaces/optical sections to select. If there are no other possible interfaces/optical sections, the method ends at step 123 with the routing not being possible. If there are other possible next optical sections, the method returns to steps 116-119 and determines if the composite path which includes the alternative next optical section is acceptable. Once step 119 has found an acceptable composite path the method proceeds to step 120 and checks if node B has been reached. If node B is reached, the method ends at step 121 with a routing achieved. If node B has not been reached the method returns to step 116 to select the next optical section.

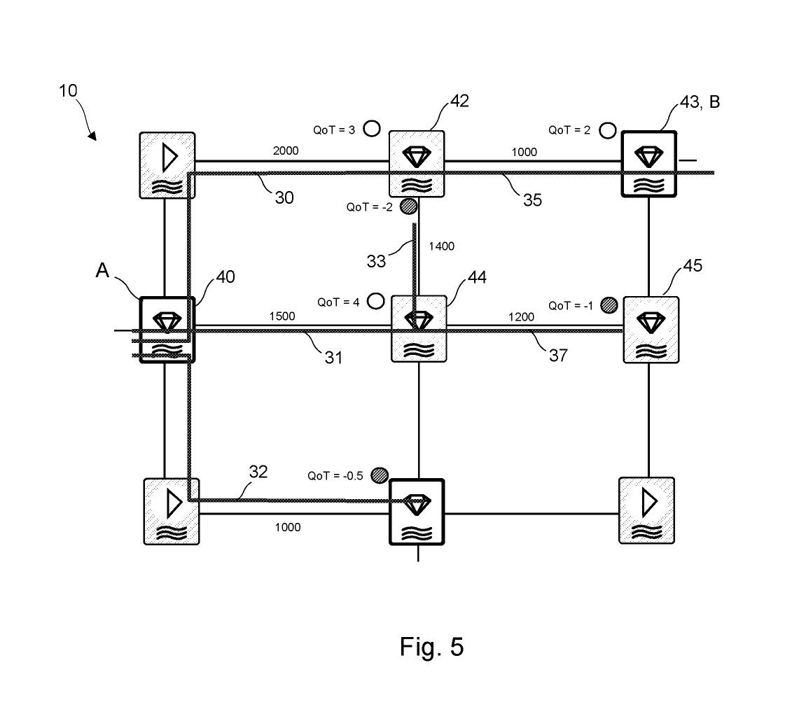

FIG. 5 illustrates several iterations of the method of route selection and evaluation performed in FIG. 3 for the network of FIG. 1. An administrative cost is shown alongside each optical section, representing a metric which is used by the routing algorithm. A connection is requested between a pair of nodes A, B, routed across the WSON 10. In this example, node A corresponds to node 40 and node B corresponds to node 43.

At a first iteration of the method, optical section 32 leading from node 40 is selected as it has the lowest administrative cost (1000 compared to 1500 or 2000). Stored parameter values are retrieved from the TED, and it is found that optical section 32 has an unacceptable quality.

The method returns to node 40 and selects the optical section leading from node A having the next lowest administrative cost. Optical section 31 is selected. Stored parameter values are retrieved from the TED, and it is found that optical section 31 has an acceptable quality. The method then selects an optical section leading from node 44 having lowest administrative cost. Stored parameter values for optical section 37 are retrieved from the TED. The PLDVE assesses feasibility of the composite path comprising optical sections 31, 37 using the stored parameter values for these sections. It is found that the composite path has an unacceptable quality. The method returns to node 44 and selects the optical section 33 leading from node 44 having the next lowest administrative cost. Stored parameter values for optical section 33 are retrieved from the TED. The PLDVE assesses feasibility of the composite path comprising optical sections 31, 33 using the stored parameter values for these sections. It is found that the composite path has an unacceptable quality.

The method returns to node 40 and selects the optical section 30 leading from node A having the next lowest administrative cost. Stored parameter values are retrieved from the TED, and it is found that optical section 30 has an acceptable quality. The method then selects optical section 35 leading from node 42 having lowest administrative cost. Stored parameter values for optical section 35 are retrieved from the TED. The PLDVE assesses feasibility of the composite path comprising optical sections 30, 35 using the stored parameter values for these sections. It is found that the composite path has an unacceptable quality. Node 43 has been reached and the method ends having found an acceptable route.

From this example, it can be understood how the QoT, for a certain traffic type, along a sequence of optical sections, can be analytically evaluated starting from the parameters, retrieved from the TED 52 of the component optical sections, without invoking the PLDE 50. At each routing step 116, 117 it is possible to quickly check if the composite path is acceptable. If the path is acceptable, a further optical section is considered. Otherwise, the routing process backtracks and attempts a different routing.

It will be understood that the method shown in FIGS. 4 and 5 is one possible strategy for determining a routing between a pair of nodes in a network and that other strategies can be used. Another possible metric which can be used with, or instead of administrative cost, is delay.

In the example shown in FIG. 5 a route is selected by minimising the administrative cost, with the QoT being used as a way of checking that the selected route meets a quality threshold. Two further examples are given:

### EXAMPLE 1

If two or more alternative lightpaths have the same (or comparable) administrative cost, select the lightpath which also maximises the QoT among them. This lightpath will have the best margin on the receiver among the paths with the best admin. cost. In practice, this is a cascade of routing on admin. cost and on QoT.

### EXAMPLE 2

If there are no feasible paths which satisfy the QoT among the ingress and egress nodes, run the PCE again with the QoT used as a cost instead of as a check, to find the lightpath which is the nearest to feasibility. The QoT will be negative on the receiver but it will be the minimum in absolute value compared to other possible paths and therefore should require the minimum hardware placement to be converted into a feasible lightpath because it is the one nearest to being feasible.

### Composite Calculations (2.5/10 G):

At step 118 of FIG. 4 the method evaluates quality of transmission (QoT) of a composite path. It will now be described how to analytically calculate the QoT for a path which is the sequence of two contiguous paths k1 and k2 (for a certain traffic type i). Path k1 can be a composite path comprising multiple contiguous optical sections resulting from a previous iteration of the method.

The OSNR of the k1+k2 path is:

OSNR_{—}i=OSNR i,k1*OSNR i,k2/(OSNR i,k1+OSNR_{—}i,k2)

The composition of OSNR according to the previous formula shall be performed in linear units (that is: OSNR_i,k1 and OSNR_i,k2 shall be converted from dB to linear, composed, and finally OSNR _i shall be converted back to dB).

The related Q_i factor of the k1+k2 path is obtained by a mapping (via numerical fitting, hash table, etc) which depends on the model of the receiver interface (i.e. transponder):

OSNR_i→Q_i

A mapping table is defined for each supported transponder type.

The penalties of the k1+k2 path are:

Q_{—}PMD_{—}i=((Q_{—}PMD_{—}i,k1)̂2+(Q_{—}PMD_{—}i,k2)̂2)̂0.5

Q_{—}CD_{—}i=((Q_{—}CD_{—}i,k1)̂0.5+(Q_{—}PMD_{—}i,k2)̂0.5)̂2

Q_{—}NL_{—}i=((Q_{—}NL_{—}i,k1)̂0.5+(Q_{—}NL_{—}i,k2)̂0.5)̂2

Q_{—}L_{—}i=Q_{—}L_{—}i,k1+Q_{—}L_{—}i,k2

The Q′ of the signal affected by penalties is estimated as:

Q′_{—}i=Q_{—}i−Q_{—}PMD_{—}i−Q_{—}CD_{—}i−Q_{—}NL_{—}i−Q_{—}L_{—}i−Q_{—}sys_{—}i

The optical connection k1+k2 is feasible if:

Q′_i≧Q_bare_i

Finally, the QoT is defined as:

QoT=Q′_{—}i−Q_bare_{—}i

Composite calculations (40 G):

The calculations at step 118 of FIG. 4 are different for 40 G traffic.

The OSNR without nonlinear penalties of the k1+k2 path is the same as described above.

OSNR=OSNR_k1*OSNR_k2/(OSNR_k1+OSNR_k2)

The composition of OSNR according to the previous formula shall again be performed in linear units.

Q_{—}NL_{—}i=((Q_{—}NL_{—}i,k1)̂0.5+(Q_{—}NL_{—}i,k2)̂0.5)̂2

The pre-FEC Q (related to pre_FEC_BER_i of the k1+k2) path is obtained by a mapping (numerical fitting, hash table, etc):

(OSNR_i)→Q_i

Nonlinearities are taken into account as:

Q′_{—}i=_{—}Q_{—}i−Q_{—}NL_{—}i

The optical connection k1+k2 is feasible if:

Q′_i≧Q_bare_i

where:

Q′_{—}i=sqrt(2)*inv_{—}erfc(2*pre_{—}FEC_{—}BER_{—}i)

Again, the QoT is defined as:

QoT=Q′_{—}i−Q_bare_{—}i

Further detail of calculating a feasibility of a composite optical path using parameters per section is given in WO2006/000510.

The method shown in FIG. 4 can be performed at a single network entity, such as a network planning tool, a network management system, or a Path Computation Element (PCE) serving a network domain. Alternatively, the steps of the method can be distributed across a number of different network entities, such as Path Computation Elements (PCE) serving different network domains.

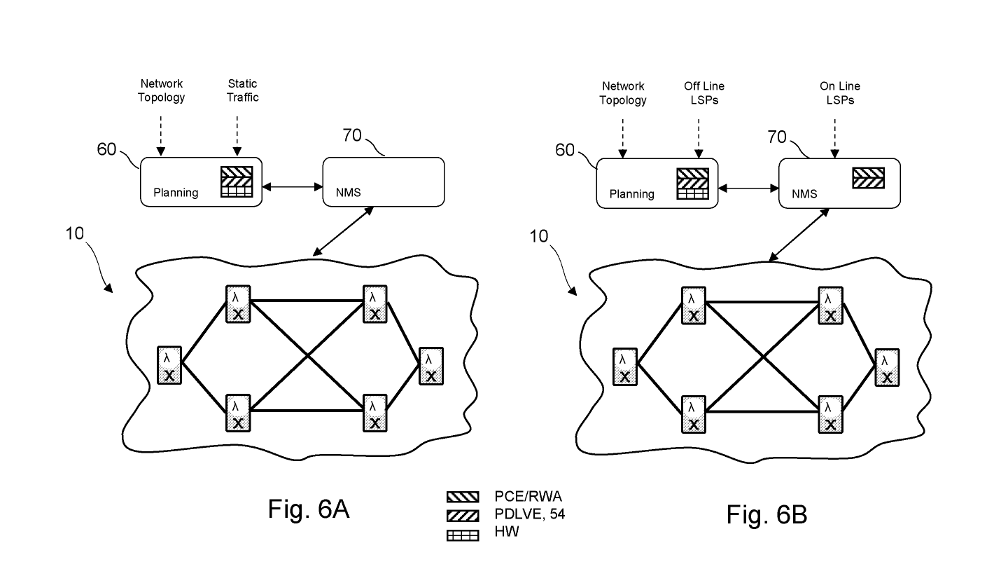

FIGS. 6A-6C show three scenarios for the location of a path computation entity within a network. The first scenario, shown in FIG. 6A, shows centralised, off-line, network planning A PLDVE 54 operates in a planning tool 60 to provide pre-planned lightpaths across the network 10. The PLDVE 54 accesses a store of per-optical section and per-interface data in a TED 52. The use of a store of pre-validated data improves the speed of operation of the planning tool. Other functions of the planning tool 60 include a Routing and Wavelength Assignment (RWA) function and a hardware provisioning function HW.

The second scenario, shown in FIG. 6B, shows centralised network planning and centralised (NMS) RWA and validation of lightpaths. A PLDVE 54 in the NMS 70 supports the provisioning of lightpaths on-the-fly. The NMS 70 responds to requests from the network 10. The PLDVE 54 in the NMS 70 can be a clone of the PLDVE used in the planning tool using the same set of equations and the same set of pre-validated data.

The third scenario, shown in FIG. 6C, shows a fully distributed control plane architecture with distributed RWA and validation of lightpaths. A PLDVE 54 and a PCE function is provided in each network node 80. The PLDVE in each node is a clone of the PLDVE used in the planning tool, using the same set of equations and the same set of pre-validated data.

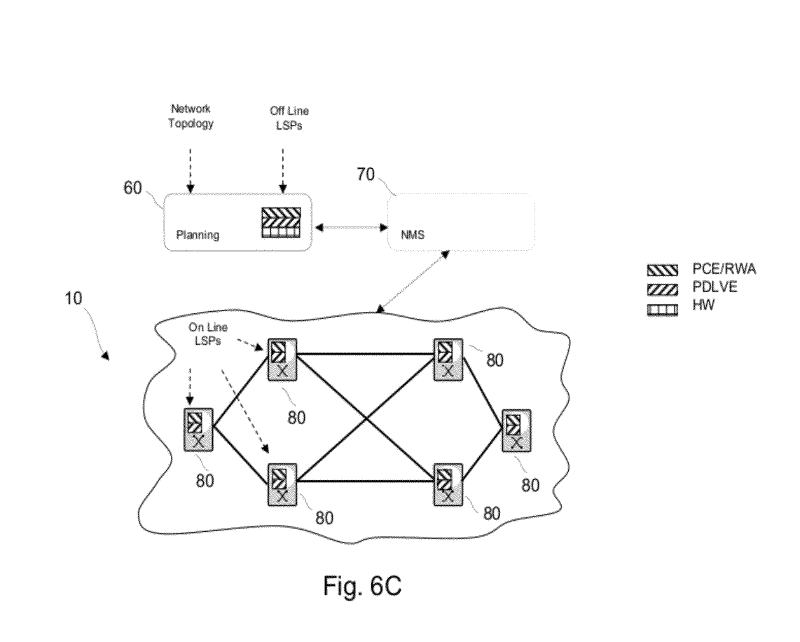

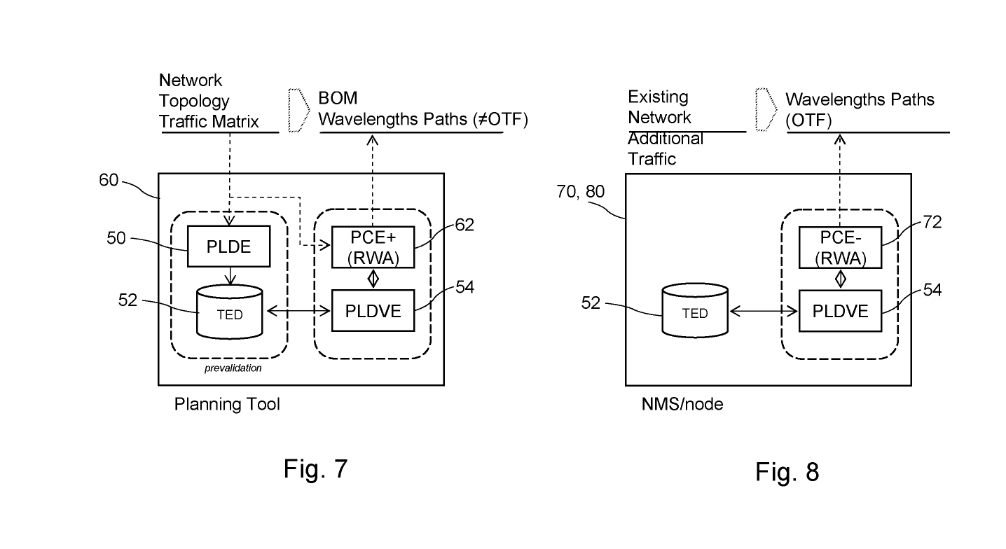

FIGS. 7 and 8 show the network entities of FIGS. 6A-6C in more detail. PLDVE 54 provides the routing engine, contained in the PCE, with a robust and fast way to assess the feasibility of the lightpaths under computation. PLDVE 54 can be set up in the network planning phase and exported and used also in a PCE embedded in the NMS or a network node.

FIG. 7 shows the Planning Tool 60. This comprises the PLDE 50 and performs the network prevalidation for the traffic types that will be involved in routing and, as a consequence, fill the TED with the physical parameters. A PLDVE 54 is also provided. A PCE+ engine is able to calculate pre-planned, off-line, lightpaths and performs resource allocation (including regenerators) using an impairments aware RWA, using the path evaluation function of the PLDVE 54. Optionally, the planning tool can perform a final feasibility verification on the routed paths using the PLDE. On the basis of the PCE+ output, a Bill Of Material (BOM) is produced.

FIG. 8 shows the Network Management System 70. In addition to the conventional management operations, it receives a copy of the TED 52 from the Planning Tool and is able to setup a PLDVE 54, which is a perfect clone of the PLDVE contained in the Planning Tool. From now on, the NMS can assess the feasibility of lightpaths in the same manner as the Planning Tool. The NMS contains the PCE- engine which is able to calculate on the fly, on-line, wavelength paths using the existing network resources. The paths are physically assessed using the cloned PLDVE. It should be understood that the PLDVE 54 comprises a set of formulas which can compute the feasibility of a composite path, using the per-section and per-interface parameters stored in the TED 52. As explained above, there is a set of formulas for 2.5/10 G bit rate traffic and a different set of formulas for 40 G bit rate traffic. Future traffic can have a further, different, set of formulas and parameters. Where a control plane is distributed across nodes of a network, the functions shown in FIG. 7 are provided in each, or selected, network nodes 80 of the network 10.

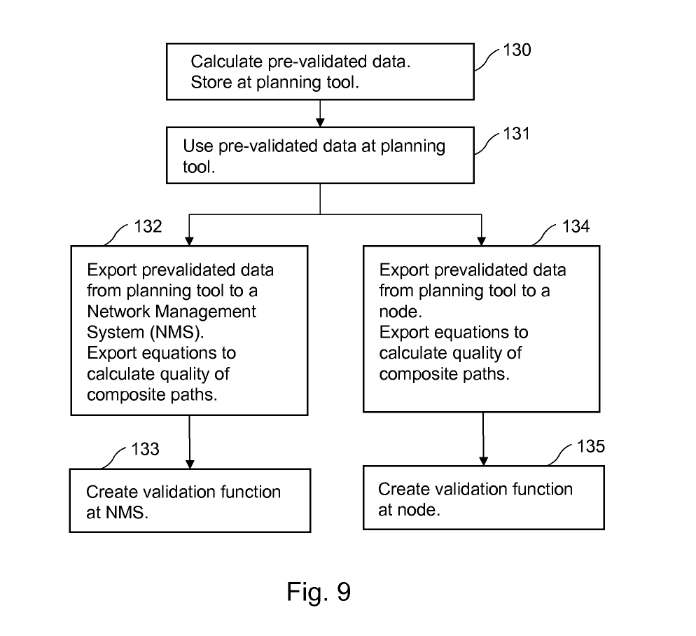

FIG. 9 shows a method of re-using prevalidated data. The method previously shown in FIG. 2 is used to create a set of prevalidated data for the network and this is stored in a TED, at step 130. The prevalidated data comprises a set of parameters for traffic types/interfaces of each optical section of the network. At step 132 the data is exported to a Network Management System 70. Equations required to calculate a quality of transmission for a composite path of the interface types in the prevalidated data are also exported. At step 133 the prevalidated data and equations can then be used to create a path validation entity (PLDVE 54) at the NMS. At step 134 the data is exported to a node 80. Equations required to calculate a quality of transmission for a composite path of the interface types in the prevalidated data are also exported. At step 135 the prevalidated data and equations can then be used to create a path validation entity (PLDVE 54) at the node. Only one of the kinds of exporting 133, 134 may be performed.

Although it has been described how the NMS, or individual node, has a PLDVE and TED which is a clone of that used in the planning tool, it should be understood that the PLDVE and TED can be created especially for the NMS or individual node.

In addition to the prevalidated data stored in TED 52, the PCE- element 72 can use impairments information which has been collected from a network protocol such as the Traffic Engineering Extensions to the Open Shortest Path First protocol or Path Computation Element communication Protocol (PCEP), and stored in TED 52. Protocol extensions to carry impairments information are described in IETF documents draft-eb-ccamp-ospf-wson-impairments-00.txt, draft-lee-pce-wson-impairments-00 and draft-bernstein-ccamp-wson-impairments-05.txt.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A method of performing routing and validation of a connection across an optical transmission network, the network comprising nodes connected by optical sections, the nodes supporting a plurality of traffic types, the method comprising:
selecting a candidate optical path as a routing for at least part of the connection on the basis of at least one routing metric, the candidate optical path having a first traffic type;
retrieving pre-computed parameters for the optical sections of the candidate optical path, the pre-computed parameters being indicative of quality of transmission along the optical section for the first traffic type; and
determining a quality of transmission along the candidate optical path using the retrieved parameters.

2. A method according to claim 1 wherein the method is performed iteratively, with each iteration of the method comprising:
selecting a candidate optical path as a routing for at least the first part of the connection;
determining if the quality of transmission along the candidate optical path is acceptable; and
modifying the candidate optical path if the quality of transmission is not acceptable.

3. A method according to claim 2 which is performed on an optical section-by-optical section basis.

4. A method according to claim 1, which is performed in response to a dynamic request for an optical connection across the optical transmission network.

5. A method according to claim 1, wherein at least one routing metric is selected from the group comprising: administrative cost, delay.

6. A method according to claim 1, wherein the step of determining a quality of transmission along the candidate optical path determines at least one parameter indicative of quality of transmission for a composite path comprising multiple optical sections by operating on the retrieved parameters for optical sections in the composite path.

7. A method according to claim 6 wherein the step of determining a quality of transmission along the candidate optical path operates on the retrieved parameters for the optical sections in the composite path using equations which are dependent on the traffic type.

8. A method according to claim 1, wherein the optical transmission network has a topology selected from the group comprising: mesh, ring, and interconnected rings.

9. A method according to claim 1, wherein the traffic type comprises at least one of: a bit rate, a line coding type and a modulation type.

10. A method according to claim 1, wherein the pre-computed parameters are selected from the group comprising: optical signal-to-noise ratio (OSNR), chromatic dispersion penalty, polarisation mode dispersion penalty, nonlinear penalty, linear penalty, and system penalty.

11. A method according to claim 1, further comprising receiving traffic engineering information and updating the pre-computed parameters using the traffic engineering information.

12. A method according to claim 1, which is performed at a network entity selected from the group comprising: a network management system, and a path computation entity at a network node.

13. An apparatus for performing routing and validation of a connection across an optical transmission network, the network comprising nodes connected by optical sections, the nodes supporting a plurality of traffic types, the apparatus comprising:
a routing module which is arranged to select a candidate optical path as a routing for at least part of the connection on the basis of at least one routing metric, the candidate optical path having a first traffic type;
a validation module which is arranged to retrieve pre-computed parameters for the optical sections of the candidate optical path, the pre-computed parameters being indicative of quality of transmission along the optical section for the first traffic type and to determine a quality of transmission along the candidate optical path using the retrieved parameters.

14. (canceled)

15. A method for use in an optical transmission network comprising nodes connected by optical sections, the method comprising:
determining, for each of the optical sections, parameters indicative of transmission quality along the optical section for a plurality of different traffic types;
storing the determined parameters for each of the optical sections at a network planning tool; and
exporting the parameters to at least one of: a network management system and a path computation entity at a node for creating a validation module for use in validating connections across the optical transmission network.

16. An apparatus for performing routing and validation of a connection across an optical transmission network, the network comprising nodes connected by optical sections, the nodes supporting a plurality of traffic types, the apparatus comprising:
a processor which is arranged to perform the following operations:
select a candidate optical path as a routing for at least part of the connection on the basis of at least one routing metric, the candidate optical path having a first traffic type;
retrieve pre-computed parameters for the optical sections of the candidate optical path, the pre-computed parameters being indicative of quality of transmission along the optical section for the first traffic type; and
determine a quality of transmission along the candidate optical path using the retrieved parameters.

17. The apparatus of claim 16, wherein the processor is further arranged to perform the operations iteratively, and with each iteration to:
determine if the quality of transmission along the candidate optical path is acceptable; and
modify the candidate optical path if the quality of transmission is not acceptable.

18. The apparatus of claim 17, wherein the processor is further arranged to perform the operations on an optical section-by-section basis.

19. The apparatus of claim 16, wherein the processor is further arranged to perform the operations in response to a dynamic request for an optical connection across the optical transmission network.

20. The apparatus of claim 16, wherein at least one routing metric is selected from a group comprising: administrative cost, delay.

21. The apparatus of claim 16, wherein the processor, to determine a quality of transmission along the candidate optical path, determines at least one parameter indicative of quality of transmission for a composite path comprising multiple optical sections by operating on the retrieved parameters for optical sections in the composite path.

22. The apparatus of claim 21, wherein the processor, to determine a quality of transmission along the candidate optical path, operates on the retrieved parameters for the optical sections in the composite path using equations which are dependent on the traffic type.

23. The apparatus of claim 16, wherein the optical transmission network has a topology selected from the group comprising: mesh, ring, and interconnected rings.

24. The apparatus of claim 16, wherein the traffic type comprises at least one of: a bit rate, a line coding type and a modulation type.

25. The apparatus of claim 16, wherein the pre-computed parameters are selected from the group comprising: optical signal-to-noise ratio (OSNR), chromatic dispersion penalty, polarisation mode dispersion penalty, nonlinear penalty, linear penalty, and system penalty.

26. The apparatus of claim 16, wherein the processor is further arranged to receive traffic engineering information and update the pre-computed parameters using the traffic engineering information.

27. The apparatus of claim 16, further comprising:
a network entity that includes the processor, the network entity selected from the group comprising: a network management system, and a path computation entity at a network node.
